(19) United States
(12) Patent Application Publication
(10) Pub. No.: US 2023/0319915 A1
(43) Pub. Date: Oct. 5, 2023

(54) USER-EQUIPMENT-TO-USER-EQUIPMENT RELAY OPERATIONS

(71) Applicant: QUALCOMM Incorporated, San Diego, CA (US)

(72) Inventors: Karthika PALADUGU, Hyderabad (IN); Hongil KIM, San Diego, CA (US); Soo Bum LEE, San Diego, CA (US); Gavin Bernard HORN, La Jolla, CA (US); Hong CHENG, Basking Ridge, NJ (US)

(21) Appl. No.: 18/184,188

(22) Filed: Mar. 15, 2023

Related U.S. Application Data
(60) Provisional application No. 63/362,513, filed on Apr. 5, 2022.

(51) Int. Cl. H04W 76/14; H04W 8/00

(52) U.S. Cl. CPC H04W 76/14; H04W 8/005; H04W 88/04

(57) ABSTRACT

Various aspects of the present disclosure generally relate to wireless communication. In some aspects, a first wireless communication device (WCD) may initiate, based at least in part on a determination to participate in user-equipment-to-user-equipment (U2U) relay communication, a discovery procedure to discover one or more of access to a second WCD or services provided by the second WCD, the second WCD being accessible via a third WCD. The WCD may communicate, for example U2U communications, with the second WCD via the third WCD based at least in part on the discovery procedure. Numerous other aspects are provided.

### CROSS-REFERENCE TO RELATED APPLICATION

This patent application claims priority to U.S. Provisional Patent Application No. 63/362,513, filed on Apr. 5, 2022, entitled “USER-EQUIPMENT-TO-USER-EQUIPMENT RELAY OPERATIONS,” and assigned to the assignee hereof. The disclosure of the prior application is considered part of and is incorporated by reference into this patent application.

### FIELD OF THE DISCLOSURE

Aspects of the present disclosure generally relate to wireless communication and specifically, to techniques and apparatuses for user-equipment-to-user-equipment relay operations, such as relay discovery or route discovery.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

Nodes, such as UEs or other wireless communication devices (WCDs), may communicate with one another via local links, such as sidelink connections. In some cases, it may be beneficial for a node (referred to herein as a WCD or a relay WCD) to relay a communication from a source node (for example, a source WCD) to a destination node (for example, a destination WCD). For example, a device-to-device network may support a first WCD attempting to communicate with a second WCD via a direct sidelink communication. However, because UEs and other WCDs are associated with lower transmit power relative to a base station or other network node, the second WCD may be out of coverage of the first WCD. Relaying may improve coverage and function of a device-to-device network in which transmit powers are generally relatively low.

### SUMMARY

Some aspects described herein relate to a method of wireless communication performed by a first wireless communication device (WCD). The method may include initiating, based at least in part on a determination to participate in user-equipment-to-user-equipment (U2U) relay communication, a discovery procedure to discover one or more of access to a second WCD or services provided by the second WCD, the second WCD being accessible via a third WCD. The method may include communicating (e.g., U2U communications) with the second WCD via the third WCD based at least in part on the discovery procedure.

Some aspects described herein relate to a method of wireless communication performed by a relay WCD. The method may include performing a discovery procedure for U2U relay communication, the discovery procedure comprising one or more of: advertising, to a first WCD or a second WCD, support for U2U relay services, transmitting a response to a solicitation from the first WCD or the second WCD, the response indicating support for U2U relay services, discovering the first WCD or the second WCD as accessible via the relay WCD, or advertising the first WCD or the second WCD as accessible via the relay WCD. The method may include relaying communications between the first WCD and the second WCD based at least in part on performing the discovery procedure.

Some aspects described herein relate to a first WCD for wireless communication. The first wireless communication device may include at least one processor and at least one memory, communicatively coupled with the at least one processor, that stores processor-readable code. The processor-readable code, when executed by the at least one processor, may be configured to cause the first wireless communication device to initiate, based at least in part on a determination to participate in U2U relay communication, a discovery procedure to discover one or more of access to a second WCD or services provided by the second WCD, the second WCD being accessible via a third WCD. The processor-readable code, when executed by the at least one processor, may be configured to cause the first wireless communication device to communicate (e.g., U2U communications) with the second WCD via the third WCD based at least in part on the discovery procedure.

Some aspects described herein relate to a relay WCD for wireless communication. The relay wireless communication device may include at least one processor and at least one memory, communicatively coupled with the at least one processor, that stores processor-readable code. The processor-readable code, when executed by the at least one processor, may be configured to cause the relay wireless communication device to perform a discovery procedure for U2U relay communication, the discovery procedure comprising one or more of: advertising to a first WCD or a second WCD to indicate support for U2U relay services, transmitting a response to a solicitation from the first WCD or the second WCD, the response indicating support for U2U relay services, discovering the first WCD or the second WCD as accessible via the relay WCD, or advertising the first WCD or the second WCD as accessible via the relay WCD. The processor-readable code, when executed by the at least one processor, may be configured to cause the relay wireless communication device to relay communications between the first WCD and the second WCD based at least in part on performing the discovery procedure.

Some aspects described herein relate to a non-transitory computer-readable medium that stores a set of instructions for wireless communication by a first WCD. The set of instructions, when executed by one or more processors of the WCD, may cause the WCD to initiate, based at least in part on a determination to participate in U2U relay communication, a discovery procedure to discover one or more of access to a second WCD or services provided by the second WCD, the second WCD being accessible via a third WCD. The set of instructions, when executed by one or more processors of the WCD, may cause the WCD to communicate (e.g., U2U communications) with the second WCD via the third WCD based at least in part on the discovery procedure.

Some aspects described herein relate to a non-transitory computer-readable medium that stores a set of instructions for wireless communication by a relay WCD. The set of instructions, when executed by one or more processors of the WCD, may cause the WCD to perform a discovery procedure for U2U relay communication, the discovery procedure comprising one or more of: advertising to a first WCD or a second WCD to indicate support for U2U relay services, transmitting a response to a solicitation from the first WCD or the second WCD, the response indicating support for U2U relay services, discovering the first WCD or the second WCD as accessible via the relay WCD, or advertising the first WCD or the second WCD as accessible via the relay WCD. The set of instructions, when executed by one or more processors of the WCD, may cause the WCD to relay communications between the first WCD and the second WCD based at least in part on performing the discovery procedure.

Some aspects described herein relate to an apparatus for wireless communication. The apparatus may include means for initiating, based at least in part on a determination to participate in U2U relay communication, a discovery procedure to discover one or more of access to a second WCD or services provided by the second WCD, the second WCD being accessible via a third WCD. The apparatus may include means for communicating (e.g., U2U communications) with the second WCD via the third WCD based at least in part on the discovery procedure.

Some aspects described herein relate to an apparatus for wireless communication. The apparatus may include means for performing a discovery procedure for U2U relay communication, the discovery procedure comprising one or more of: advertising to a first WCD or a second WCD to indicate support for U2U relay services, transmitting a response to a solicitation from the first WCD or the second WCD, the response indicating support for U2U relay services, discovering the first WCD or the second WCD as accessible via the relay WCD, or advertising the first WCD or the second WCD as accessible via the relay WCD. The apparatus may include means for relaying communications between the first WCD and the second WCD based at least in part on performing the discovery procedure.

Aspects generally include a method, apparatus, system, computer program product, non-transitory computer-readable medium, user equipment, base station, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example base station in communication with a user equipment (UE) in a wireless network in accordance with the present disclosure.

FIG. 3 is a diagram illustrating an example of sidelink communications in accordance with the present disclosure.

FIG. 4 is a diagram illustrating an example associated with sidelink communications and access link communications in accordance with the present disclosure.

FIGS. 5A and 5B are diagrams illustrating examples of a first discovery model and a second discovery model for UEs performing sidelink communications in accordance with the present disclosure.

FIG. 6 is a diagram illustrating an example of a user plane protocol stack for Layer 2 UE-to-UE relaying and an example of a user plane protocol stack for Layer 3 UE-to-UE relaying in accordance with the present disclosure.

FIGS. 7-10 are diagrams illustrating examples associated with UE-to-UE (U2U) relay operations in accordance with the present disclosure.

FIGS. 11 and 12 are flowcharts illustrating example processes performed, for example, by a wireless communication device (WCD) in accordance with the present disclosure.

FIGS. 13 and 14 are diagrams of example apparatuses for wireless communication in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to UE-to-UE (U2U) relay operations. Some aspects more specifically relate to relay discovery or route discovery for U2U relay operations. In some aspects, the relay discovery or route discovery may be associated with single-hop relaying in which a single relay WCD supports communications between a source WCD and a destination WCD. In some aspects (for example, after the source WCD first fails to reach the destination WCD directly), the source WCD may use a proximity services (ProSe) policy to determine one or more relay service codes (RSCs) to use for U2U relay discovery. The source WCD may use parameters associated with the one or more RSCs to discover access to the destination WCD or services provided by the destination WCD via the relay WCD.

Particular aspects of the subject matter described in this disclosure can be implemented to realize one or more of the following potential advantages. In some examples, the described techniques can be used to improve latency in communicating via a relay WCD (for example, based at least in part on improved discovery of the relay WCD and routing to the destination WCD). Additionally or alternatively, the described techniques can be used to improve a quality of service and error rates of communications from the source WCD to the destination WCD based at least in part on using the techniques to improve route selection, among other examples.

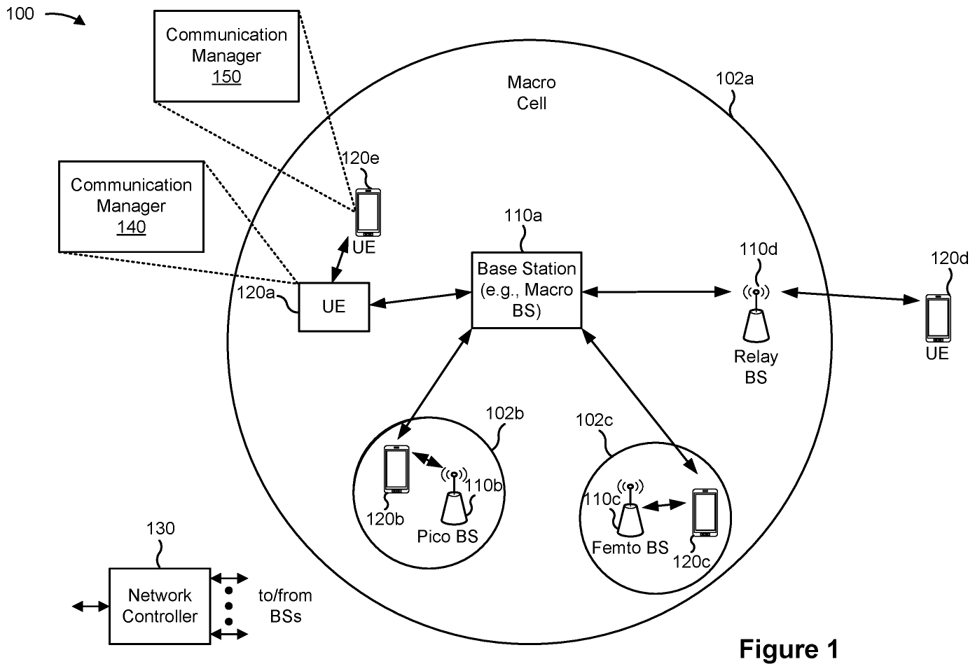

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), or other network entities. A base station 110 is an entity that communicates with UEs 120. A base station 110 (sometimes referred to as a BS) may include, for example, an NR base station, an LTE base station, a Node B, an eNB (for example, in 4G), a gNB (for example, in 5G), an access point, or a transmission reception point (TRP). Each base station 110 may provide communication coverage for a particular geographic area. In the Third Generation Partnership Project (3GPP), the term “cell” can refer to a coverage area of a base station 110 or a base station subsystem serving this coverage area, depending on the context in which the term is used.

A base station 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station.

The wireless network 100 may be a heterogeneous network that includes base stations 110 of different types, such as macro base stations, pico base stations, femto base stations, or relay base stations. These different types of base stations 110 may have different transmit power levels, different coverage areas, or different impacts on interference in the wireless network 100. For example, macro base stations may have a high transmit power level (for example, 5 to 40 watts) whereas pico base stations, femto base stations, and relay base stations may have lower transmit power levels (for example, 0.1 to 2 watts). In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (for example, three) cells. A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

In some examples, a cell may not necessarily be stationary, and the geographic area of the cell may move in accordance with the location of a base station 110 that is mobile (for example, a mobile base station). In some examples, the base stations 110 may be interconnected to one another or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a base station 110 or a UE 120) and send a transmission of the data to a downstream station (for example, a UE 120 or a base station 110). A relay station may be a UE 120 that can relay transmissions for other UEs 120. In the example shown in FIG. 1, the BS 110d (for example, a relay base station) may communicate with the BS 110a (for example, a macro base station) and the UE 120d in order to facilitate communication between the BS 110a and the UE 120d. A base station 110 that relays communications may be referred to as a relay station, a relay base station, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a base station, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a base station 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the base station 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz,” if used herein, may broadly represent frequencies that may be less than 6 GHz, may be within FR1, or may include mid-band frequencies. Further, unless specifically stated otherwise, it should be understood that the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the first wireless communication device (WCD) may include a communication manager 140. As described in more detail elsewhere herein, the communication manager 140 may initiate, based at least in part on a determination to participate in U2U relay communication, a discovery procedure to discover one or more of access to a second WCD or services provided by the second WCD, the second WCD being accessible via a third WCD; and communicate (e.g., U2U communications) with the second WCD via the third WCD based at least in part on the discovery procedure. Additionally or alternatively, the communication manager 140 may perform one or more other operations described herein.

In some aspects, the relay WCD may include a communication manager 150. As described in more detail elsewhere herein, the communication manager 150 may perform a discovery procedure for U2U relay communication, the discovery procedure comprising one or more of: advertise to a first WCD or a second WCD to indicate support for U2U relay services, respond to a solicitation from the first WCD or the second WCD to indicate support for U2U relay services, discover the first WCD or the second WCD as accessible via the relay WCD, or advertise the first WCD or the second WCD as accessible via the relay WCD; and relay communications between the first WCD and the second WCD based at least in part on performing the discovery procedure. Additionally or alternatively, the communication manager 150 may perform one or more other operations described herein.

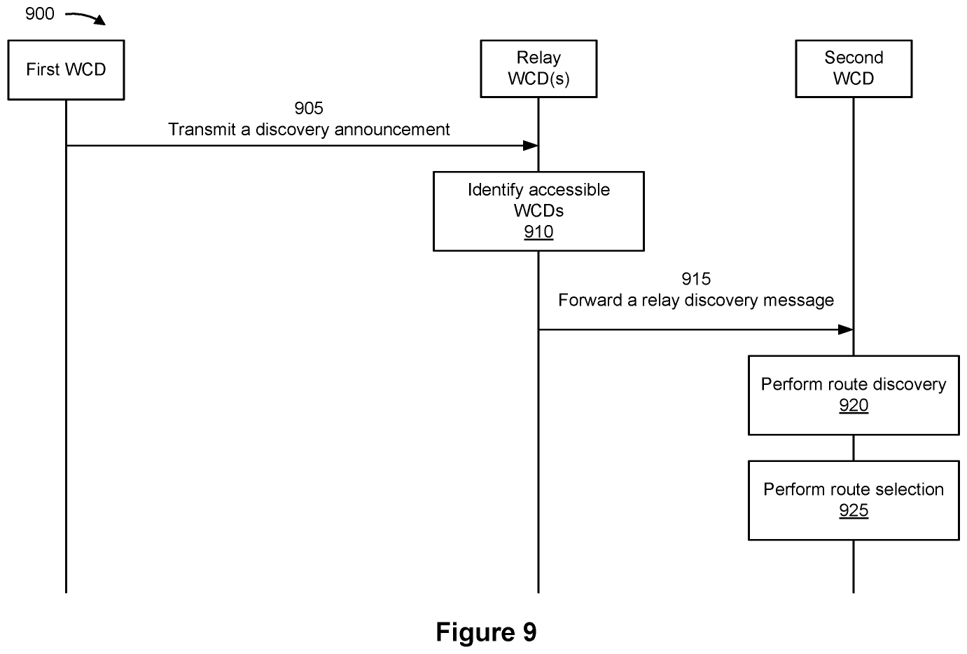

In some aspects, the term “base station” (for example, the base station 110) or “network node” or “network entity” may refer to an aggregated base station, a disaggregated base station (for example, described in connection with FIG. 9), an integrated access and backhaul (IAB) node, a relay node, or one or more components thereof. For example, in some aspects, “base station,” “network node,” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station,” “network node,” or “network entity” may refer to one device configured to perform one or more functions, such as those described herein in connection with the base station 110. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations or one or more virtual base station functions. For example, in some aspects, two or more base station functions may be instantiated on a single device. In some aspects, the term “base station,” “network node,” or “network entity” may refer to one of the base station functions and not another. In this way, a single device may include more than one base station.

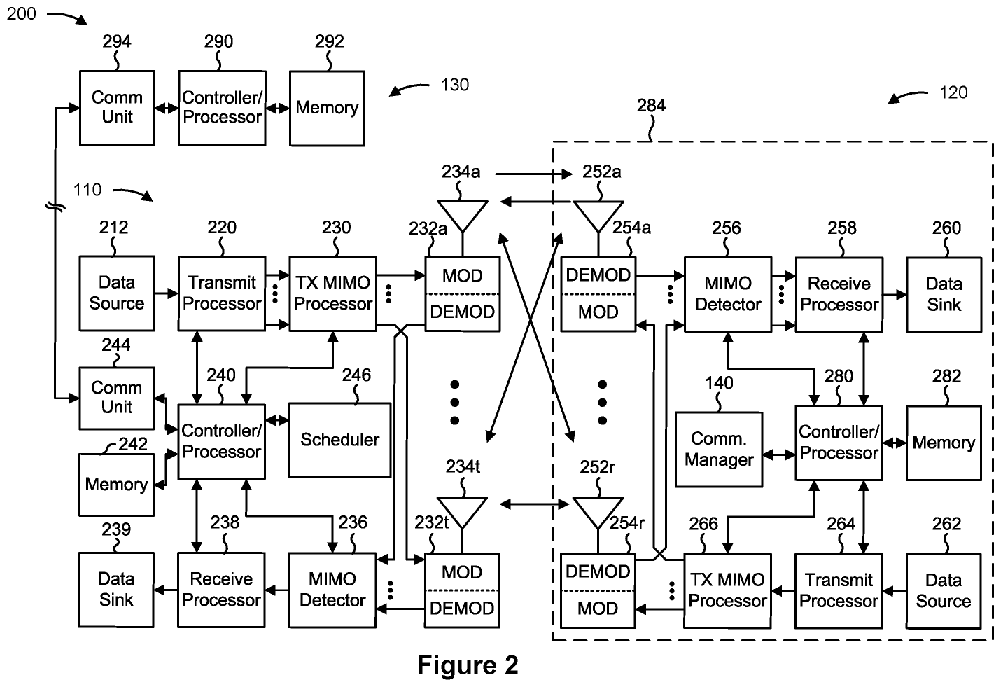

FIG. 2 is a diagram illustrating an example base station in communication with a UE in a wireless network in accordance with the present disclosure. The base station may correspond to the base station 110 of FIG. 1. Similarly, the UE may correspond to the UE 120 of FIG. 1. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the base station 110 or other base stations 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the base station 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

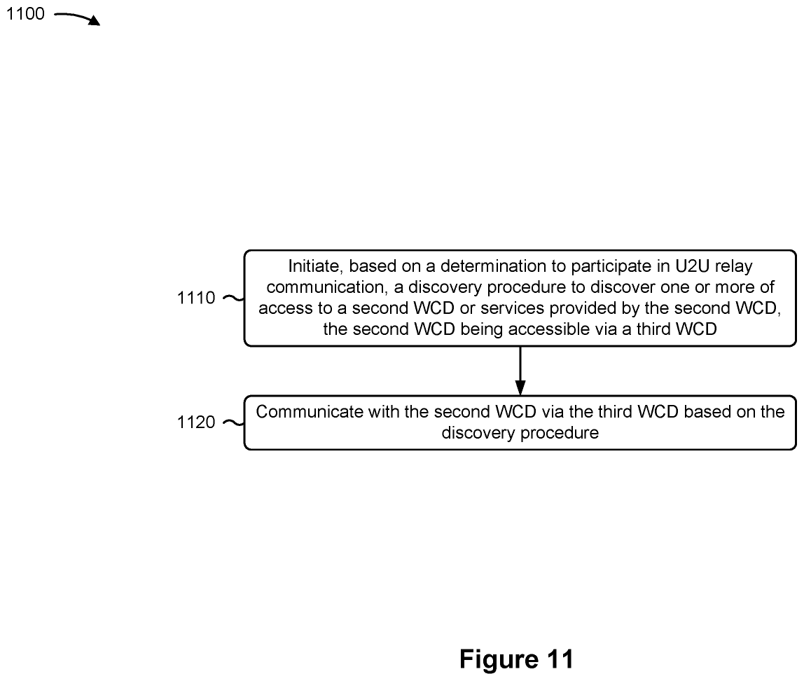

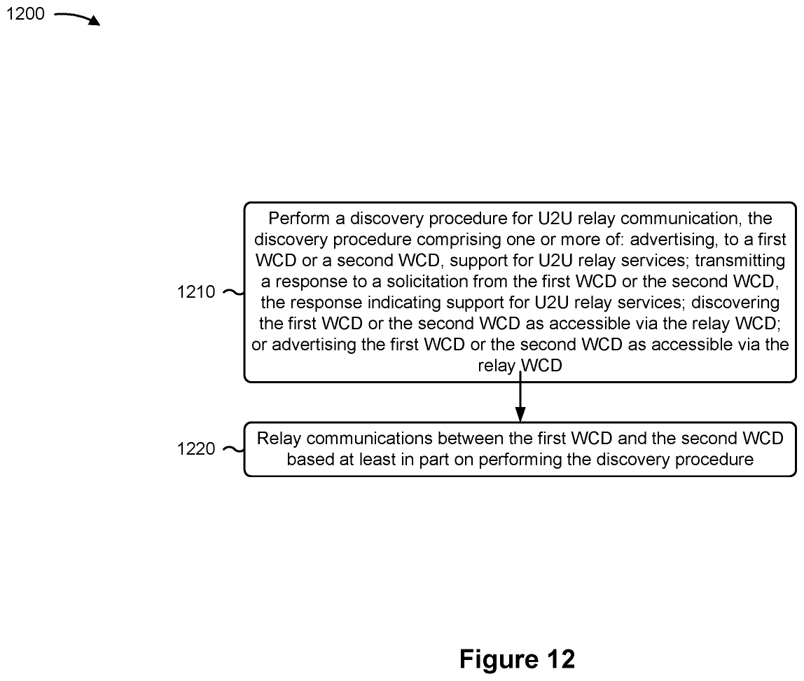

The controller/processor 240 of the base station 110, the controller/processor 280 of the UE 120, or any other component(s) of FIG. 2 may perform one or more techniques associated with U2U relay operations, such as relay discovery or route discovery, as described in more detail elsewhere herein. In some aspects, the first WCD, the second WCD, the third WCD, or the relay WCD described herein is the UE 120 (for example, UE 120a or UE 120e), is included in the UE 120, or includes one or more components of the UE 120 shown in FIG. 2. For example, the controller/processor 240 of the base station 110, the controller/processor 280 of the UE 120, or any other component(s) of FIG. 2 may perform or direct operations of, for example, process 1100 of FIG. 11, process 1200 of FIG. 12, or other processes as described herein. The memory 242 and the memory 282 may store data and program codes for the base station 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the base station 110 or the UE 120, may cause the one or more processors, the UE 120, or the base station 110 to perform or direct operations of, for example, process 1100 of FIG. 11, process 1200 of FIG. 12, or other processes as described herein. In some examples, executing instructions may include running the instructions, converting the instructions, compiling the instructions, or interpreting the instructions, among other examples.

In some aspects, the first WCD includes means for initiating, based at least in part on a determination to participate in U2U relay communication, a discovery procedure to discover one or more of access to a second WCD or services provided by the second WCD, the second WCD being accessible via a third WCD; or means for communicating (e.g., U2U communications) with the second WCD via the third WCD based at least in part on the discovery procedure. In some aspects, the means for the first WCD to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the relay WCD includes means for performing a discovery procedure for U2U relay communication, the discovery procedure comprising one or more of: means for advertising to a first WCD or a second WCD to indicate support for U2U relay services, means for transmitting a response to a solicitation from the first WCD or the second WCD, the response indicating support for U2U relay services, means for discovering the first WCD or the second WCD as accessible via the relay WCD, or means for advertising the first WCD or the second WCD as accessible via the relay WCD; or means for relaying communications between the first WCD and the second WCD based at least in part on performing the discovery procedure. In some aspects, the means for the relay WCD to perform operations described herein may include, for example, one or more of communication manager 140, antenna 252, modem 254, MIMO detector 256, receive processor 258, transmit processor 264, TX MIMO processor 266, controller/processor 280, or memory 282.

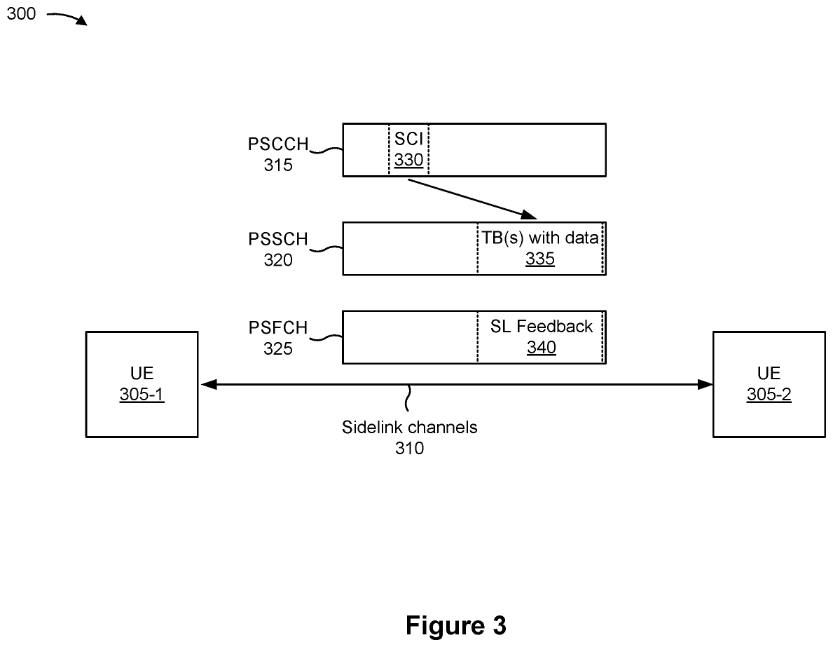

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (for example, which may include V2V communications, V2I communications, or V2P communications) or mesh networking. In some aspects, the UEs 305 (for example, UE 305-1 or UE 305-2) may correspond to one or more other UEs described elsewhere herein, such as UE 120. In some aspects, the one or more sidelink channels 310 may use a PC5 interface or may operate in a high frequency band (for example, the 5.9 GHz band). Additionally or alternatively, the UEs 305 may synchronize timing of transmission time intervals (TTIs) (for example, frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, or a physical sidelink feedback channel (PSFCH) 325. The PSCCH 315 may be used to communicate control information, similar to a physical downlink control channel (PDCCH) or a physical uplink control channel (PUCCH) used for cellular communications with a base station 110 via an access link or an access channel. The PSSCH 320 may be used to communicate data, similar to a physical downlink shared channel (PDSCH) or a physical uplink shared channel (PUSCH) used for cellular communications with a base station 110 via an access link or an access channel. For example, the PSCCH 315 may carry sidelink control information (SCI) 330, which may indicate various control information used for sidelink communications, such as one or more resources (for example, time resources, frequency resources, or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (for example, acknowledgement or negative acknowledgement (ACK/NACK) information), transmit power control (TPC), or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (for example, time resources, frequency resources, or spatial resources) on the PSSCH 320, information for decoding sidelink communications on the PSSCH, a quality of service (QoS) priority value, a resource reservation period, a PSSCH DMRS pattern, an SCI format for the SCI-2, a beta offset for the SCI-2, a quantity of PSSCH DMRS ports, or an MCS. The SCI-2 may include information associated with data transmissions on the PSSCH 320, such as a HARQ process ID, a new data indicator (NDI), a source identifier, a destination identifier, or a channel state information (CSI) report trigger.

In some aspects, the one or more sidelink channels 310 may use resource pools. For example, a scheduling assignment (for example, included in SCI 330) may be transmitted in sub-channels using specific resource blocks (RBs) across time. In some aspects, data transmissions (for example, on the PSSCH 320) associated with a scheduling assignment may occupy adjacent RBs in the same subframe as the scheduling assignment (for example, using frequency division multiplexing). In some aspects, a scheduling assignment and associated data transmissions are not transmitted on adjacent RBs.

In some aspects, a UE 305 may operate using a sidelink transmission mode (for example, Mode 1) where resource selection or scheduling is performed by a base station 110. For example, the UE 305 may receive a grant (for example, in downlink control information (DCI) or in a radio resource control (RRC) message, such as for configured grants) from the base station 110 for sidelink channel access or scheduling. In some aspects, a UE 305 may operate using a transmission mode (for example, Mode 2) where resource selection or scheduling is performed by the UE 305 (for example, rather than a base station 110). In some aspects, the UE 305 may perform resource selection or scheduling by sensing channel availability for transmissions. For example, the UE 305 may measure an RSSI parameter (for example, a sidelink-RSSI (S-RSSI) parameter) associated with various sidelink channels, may measure an RSRP parameter (for example, a PSSCH-RSRP parameter) associated with various sidelink channels, or may measure an RSRQ parameter (for example, a PSSCH-RSRQ parameter) associated with various sidelink channels, and may select a channel for transmission of a sidelink communication based at least in part on the measurement(s).

Additionally or alternatively, the UE 305 may perform resource selection or scheduling using SCI 330 received in the PSCCH 315, which may indicate occupied resources or channel parameters. Additionally or alternatively, the UE 305 may perform resource selection or scheduling by determining a channel busy ratio (CBR) associated with various sidelink channels, which may be used for rate control (for example, by indicating a maximum number of resource blocks that the UE 305 can use for a particular set of subframes).

In the transmission mode where resource selection or scheduling is performed by a UE 305, the UE 305 may generate sidelink grants, and may transmit the grants in SCI 330. A sidelink grant may indicate, for example, one or more parameters (for example, transmission parameters) to be used for an upcoming sidelink transmission, such as one or more resource blocks to be used for the upcoming sidelink transmission on the PSSCH 320 (for example, for TBs 335), one or more subframes to be used for the upcoming sidelink transmission, or an MCS to be used for the upcoming sidelink transmission. In some aspects, a UE 305 may generate a sidelink grant that indicates one or more parameters for semi-persistent scheduling (SPS), such as a periodicity of a sidelink transmission. Additionally or alternatively, the UE 305 may generate a sidelink grant for event-driven scheduling, such as for an on-demand sidelink message.

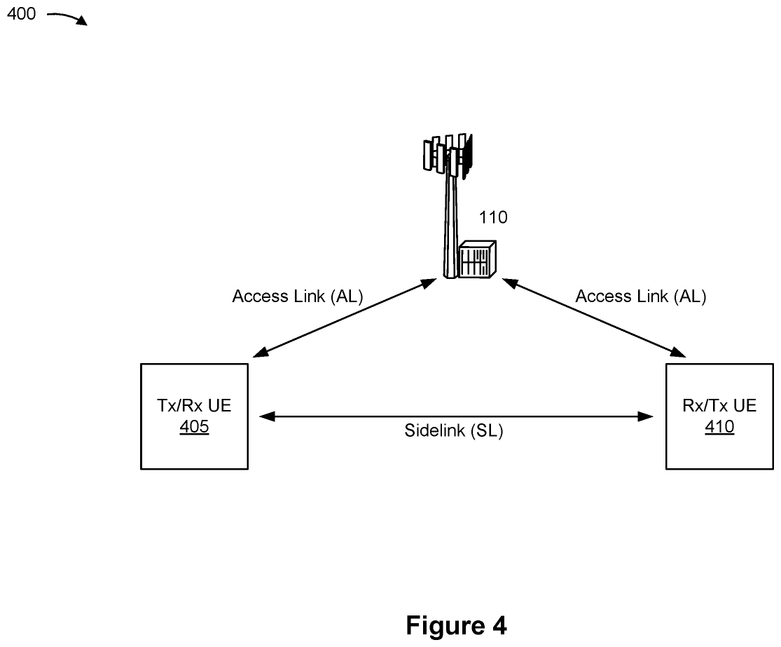

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a base station 110 may communicate with the Tx/Rx UE 405 via a first access link. Additionally or alternatively, in some sidelink modes, the base station 110 may communicate with the Rx/Tx UE 410 via a second access link. The Tx/Rx UE 405 or the Rx/Tx UE 410 may correspond to one or more UEs described elsewhere herein, such as the UE 120 of FIG. 1. Thus, a direct link between UEs 120 (for example, via a PC5 interface) may be referred to as a sidelink, and a direct link between a base station 110 and a UE 120 (for example, via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110).

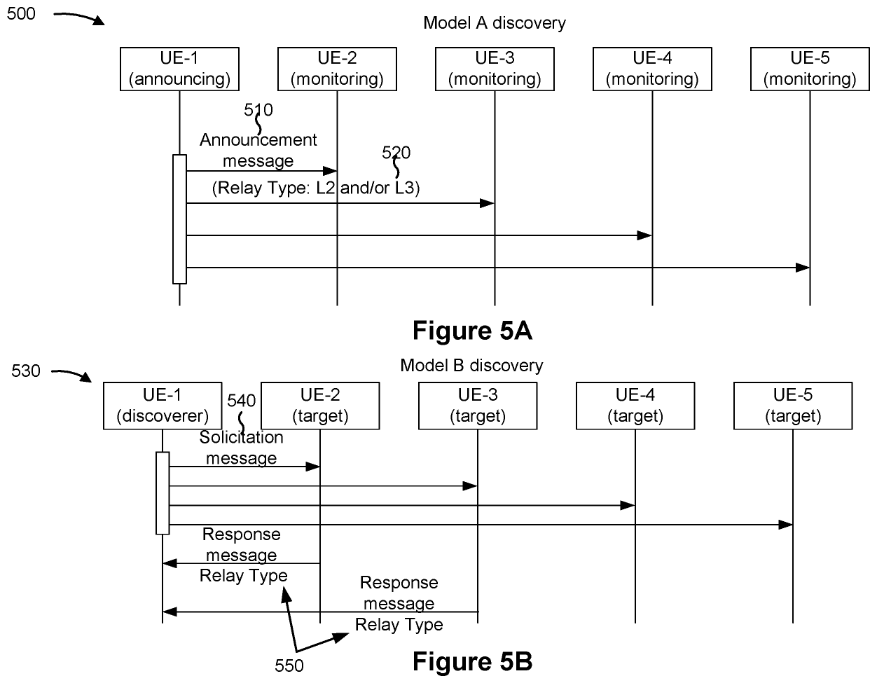

FIGS. 5A and 5B are diagram illustrating examples 500 and 530 of a first discovery model and a second discovery model for UEs performing sidelink communications, in accordance with the present disclosure. The description of examples 500 and 530 provides UEs as examples of nodes which may perform the operations of examples 500 and 530. However, examples 500 and 530 can be implemented using another type of node, such as a wireless communication device other than a UE.

The first discovery model may be referred to as Model A. In the first discovery model, a first UE (for example, UE-1, or an announcing UE) may transmit an announcement message shown by reference number 510. As shown by reference number 520, the announcement message may indicate one or more relay types that the first UE is capable of performing (for example, L2 relaying, Layer 3 relaying, unicast relaying, or groupcast/broadcast relaying, among other examples). For example, the announcement message may include a flag or field, such as a relay service code, indicating the one or more relay types. One or more second UEs (for example, UE-2 through UE-5, or monitoring UEs) may monitor for the announcement message.

In example 530 of FIG. 5B, the second discovery model is illustrated. The second discovery model may be referred to as Model B. As shown, example 530 includes a discoverer UE (for example, UE-1) and a set of target UEs (for example, UE-2 through UE-5).

As shown by reference number 540, the discoverer UE may transmit a solicitation message. In some aspects, the solicitation message may indicate one or more relay types that the discoverer UE is capable of performing or desires to use (for example, L2 relaying, Layer 3 relaying, unicast relaying, groupcast relaying, broadcast relaying, or a combination thereof, among other examples). For example, the solicitation message may include a flag or field, such as a relay service code, indicating the one or more relay types. As shown by reference number 550, target UEs that receive the solicitation message may provide a response message that indicates one or more relay types supported by the target UE. In some aspects, a target UE may respond if the target UE receives the solicitation message and supports a relay type indicated by the solicitation message.

In examples 500 and 530, a policy (for example, a ProSe policy among other examples) may provide authorization or operational parameters for the UEs of examples 500 and 530. For example, the authorization or operational parameters may indicate authorization or operational parameters associated with UE-to-UE relaying, described in more detail below. UEs in coverage of a network may receive such a policy from the network. UEs out of coverage of the network may use a preconfigured policy.

Discovery may be used to identify UEs for UE-to-UE relaying. A UE that identifies another UE according to the techniques described with regard to FIGS. 5A and 5B may be referred to as discovering the other UE. For example, a remote UE (which may be a source UE or a destination UE) may discover a relay UE using the technique described with regard to FIGS. 5A and 5B. As another example, a relay UE may discover a remote UE using Model A discovery. As yet another example, a relay UE may determine reachability of a remote UE via Model B discovery (for example, the relay UE may transmit a solicitation message and may determine a remote UE is reachable if the remote UE responds to the solicitation message).

In some aspects, a discovery message (such as a solicitation message, a response to a solicitation message, or an announcement message) may include location information (for example, a location identifier). For example, a UE transmitting a discovery message (for example, a remote UE or a relay UE) may include the location information in the discovery message, or may transmit the location information with the discovery message. A discovery message associated with a relay node may include or be associated with location information for the relay node. In some aspects, the location information may include a zone identifier. For example, a sidelink radio access technology may provide for the division of an area into multiple zones, each of which is associated with a zone identifier. A relay UE may use the zone identifier to determine or store information indicating which remote UEs (for example, destination UEs or source UEs) are reachable by the relay UE. For example, the relay UE may maintain a list of reachable remote UEs, which may indicate a range (for example, a distance or a range of distances) to each of the reachable remote UEs (for example, one range per reachable remote UE). The range may be determined based at least in part on the location information of the UE transmitting the discovery message and the location information of the UE receiving the discovery message. In some aspects, the relay UE may advertise the list of reachable remote UEs during discovery. For example, the relay UE may transmit information indicating the list of reachable remote UEs (for example, an indication of one or more reachable remote UEs associated with the relay UE), such as via a discovery message. In this way, a source UE can identify one or more relay UEs for relaying a communication based at least in part on the remote UEs reachable by the one or more relay UEs. A UE may be considered reachable if the UE is within a threshold range of another UE, associated with a threshold signal strength at the other UE, or associated with a capability indicating reachability, among other examples.

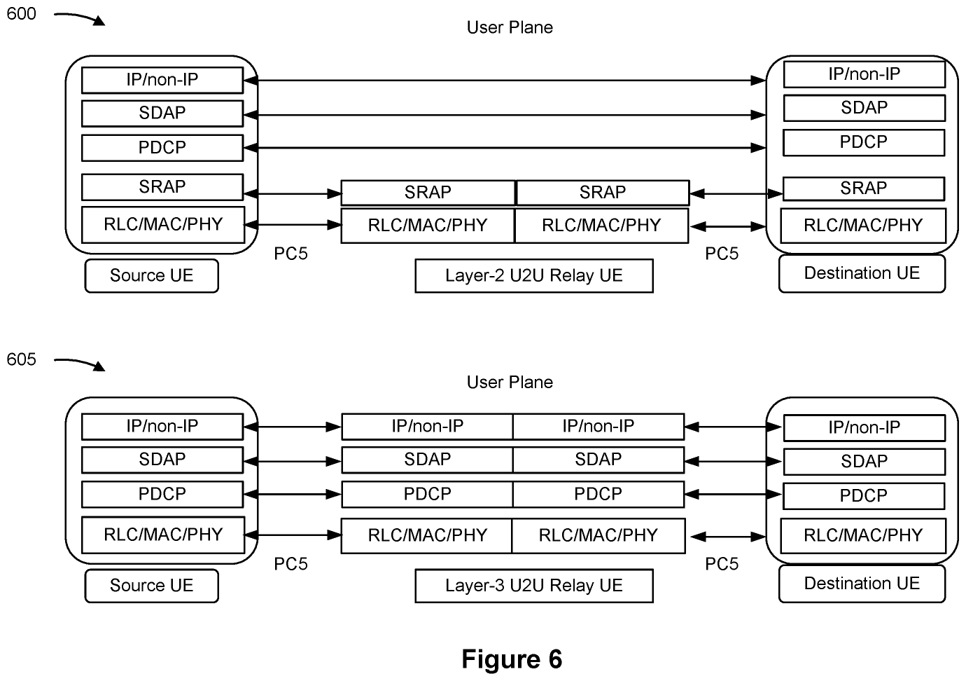

FIG. 6 is a diagram illustrating an example 600 of a user plane protocol stack for Layer 2 UE-to-UE relaying and an example 605 of a user plane protocol stack for Layer 3 UE-to-UE relaying, in accordance with the present disclosure. The description of examples 600 and 605 provides UEs as examples of nodes which may perform the operations of examples 600 and 605. However, examples 600 and 605 can be implemented using another type of node, such as a wireless communication device other than a UE. As shown, examples 600 and 605 include a source UE (for example, UE 120, UE 305, UE 405), a relay UE (for example, UE 120, UE 305, UE 405), and a destination UE (for example, UE 120, UE 305, UE 405). As mentioned elsewhere herein, “remote UE” may refer to either the source UE or the destination UE. The UEs of examples 600 and 605 may communicate with one another via local links. The local links are illustrated as sidelink communication links (using a PC5 interface) but can include other forms of communication link (such as WiFi or Bluetooth, among other examples).

The source UE may transmit a transmission. The relay UE may relay the transmission to the destination UE. In some aspects, the relay UE may relay the transmission to multiple destination UEs, such as via multi-node communication such as groupcast or broadcast signaling. The relaying of transmissions is described in more detail elsewhere herein.

As shown, the source UE, the destination UE, and the relay UE may be associated with respective lower-layer entities, such as a radio link control (RLC) entity, a medium access control (MAC) entity, or a physical (PHY) entity, among other examples.

As shown in examples 600 and 605, the source UE and the destination UE's user plane protocol stacks may include an internet protocol (IP) or non-IP (IP/non-IP) entity, a service data adaption protocol (SDAP) component, and a packet data convergence protocol (PDCP) component. Furthermore, as shown in example 605, the relay UE's user plane protocol stack for Layer 3 UE-to-UE relaying may include an IP/non-IP entity, an SDAP component, and a PDCP component, which may handle relaying based at least in part on Layer 3 identifiers, as described elsewhere herein.

As shown in example 600, in the user plane protocol stack for Layer 2 UE-to-UE relaying, the source UE, the relay UE, and the destination UE may each include an adaptation layer (for example, adaptation layer entity), shown as a sidelink relay adaptation protocol (SRAP) layer entity. The adaptation layer entity of the relay UE may handle relaying from the source UE to the destination UE. In some aspects, the adaptation layer entity may be a separate entity between a radio link control entity and a packet data convergence entity. In some aspects, the adaptation layer entity may be logically part of the packet data convergence entity or the radio link control entity. In Layer 2 relaying, a PDCP packet is provided to the adaptation layer (that is, Layer 2) of the source UE with a header having routing information. The RLC/MAC/PHY layer of the relay UE may receive the packet and the header, and may provide the packet and the header to the adaptation layer of the relay UE. The adaptation layer of the relay UE may use the routing information indicated by the header to route the packet to the destination UE. The destination UE's RLC/MAC/PHY layer may receive the packet and provide the packet to the adaptation layer. The adaptation layer may remove a header from the packet and may provide the packet to the upper layer entities (for example, PDCP/SDAP/IP/non-IP entities). Thus, Layer 2 relaying does not involve upper layer entities at the relay UE. Techniques described herein are also applicable for Layer 3 relaying. In Layer 3 relaying, relaying and routing is handled by an IP layer of the relay UE, the source UE, and the destination UE.

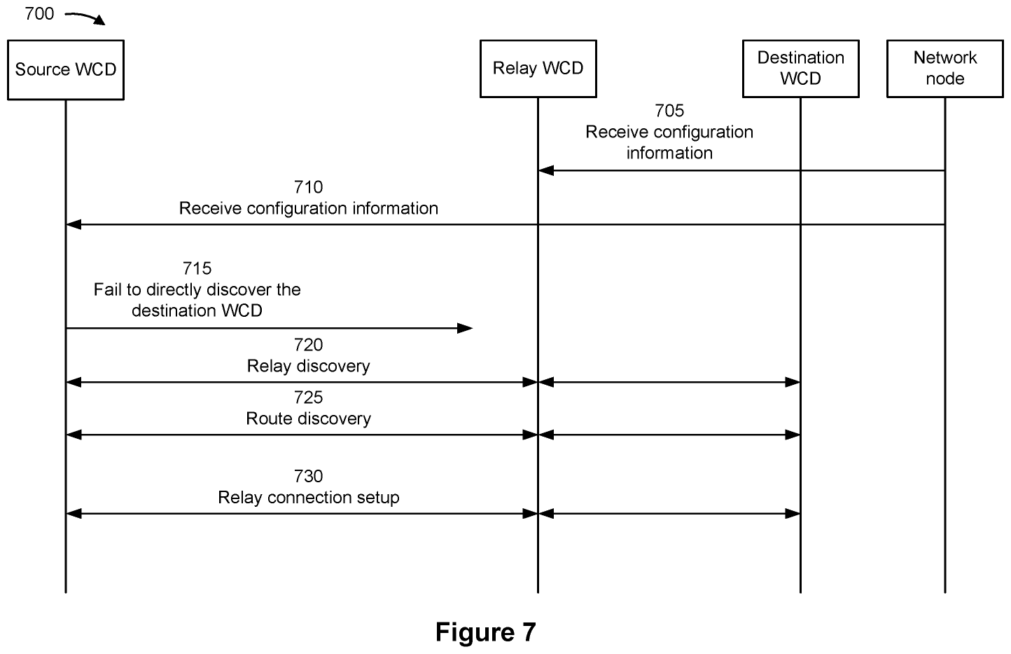

FIG. 7 is a diagram illustrating an example 700 of U2U relay operations, such as relay discovery or route discovery, in accordance with the present disclosure. As shown in FIG. 7, source WCD (for example, a source UE) may attempt to communicate with a destination WCD (for example, a destination UE) via a relay WCD (for example, a relay UE). Before the operations of example 700, the source WCD may be unaware of the presence of the relay WCD or a route to the destination WCD via the relay WCD. In some networks, multiple relay WCDs may provide different routes to the destination WCD.

In a first operation 705, the relay WCD may receive configuration information from a network node. The configuration information may indicate one or more parameters for providing U2U relay services. For example, the configuration information may indicate U2U relay service authorization (for example, based at least in part on receiving authentication information from the relay WCD) or may provision one or more configurations for performing the U2U relay services.

In some aspects, the relay WCD may transmit, and the network node may receive, an indication of a capability of the relay WCD to perform ProSe operations. For example, the relay WCD may transmit the indication of the capability to an access and mobility management function (AMF) associated with the network node. The AMF may select a policy control function (PCF) for provisioning the relay WCD based at least in part on the indication of the capability. For example, the indication may include a ProSe policy provisioning request in a WCD policy container, and the AMF may forward the ProSe policy provisioning request to the PCF (for example, transparently). The PCF may provide a policy to the AMF for delivery (for example, with the configuration information described in connection with operation 705) to the relay WCD via the network node (for example, a RAN network node).

In some aspects, the relay WCD may be out of coverage of the network node and may be preconfigured (for example, based at least in part on a communication standard or configuration information received while in coverage of the network node, among other examples) with one or more policy parameters. For example, the one or more policy parameters may be associated with the U2U relay service authorization or the one or more configurations for performing the U2U relay services, among other examples.

In a second operation 710, the source WCD may receive configuration information from the network node. The configuration information may indicate one or more parameters for performing relay discovery or route discovery for U2U relay services. For example, the configuration information may indicate U2U relay service authorization (for example, based at least in part on receiving authentication information from the relay WCD) or may provision one or more configurations for performing U2U communications.

In a third operation 715, the source WCD may fail to directly discover the destination WCD. For example, the source WCD may use an application for communicating with the destination WCD. The source WCD may determine (for example, based at least in part on a ProSe communication path selection policy) whether to communicate with the destination WCD via a PC5 connection (for example, a direct or sidelink connection) or via a Uu path (for example, a connection via the network node). Based at least in part on selecting a PC5 connection, the source WCD may attempt a ProSe direct discovery of the destination WCD. If the destination WCD were found via direct discovery, the source WCD and the destination WCD may begin communicating directly. However, based at least in part on the source WCD failing to directly discover the destination WCD, the source WCD may obtain one or more U2U relay discovery parameters (e.g., RSCs) based at least in part on a ProSe policy for U2U relay discovery.

The ProSe policy for U2U relay discovery may indicate an application identification or service type to RSC mapping. The RSC may indicate a source WCD user information identifier, one or more additional RSCs that can be used (for example, using different layer options), or one or more U2U relay layer indicators (for example, layer-3 or layer-2). In some aspects, the ProSe policy for U2U relay discovery may indicate a discovery relaying default destination layer-2 identification (for example, a destination identification used for transmitting one or more discovery messages).

In a fourth operation 720 the source WCD, the relay WCD and the destination WCD may perform relay WCD discovery. For example, the source WCD, the relay WCD and the destination WCD may perform Model A discovery or Model B discovery operations, as described in connection with FIG. 5A or 5B.

In some aspects, relay discovery may include one or more discovery messages transmitted using a sidelink SL-signaling resource bearer (for example, SRB4). In some aspects, the one or more discovery messages may not use PDCP security for discovery. The messages may be transmitted using shared or dedicated resource pools. A configuration for relay discovery may be based at least in part on SIB or dedicated signaling for in-coverage WCDs or a pre-configuration for out-of-coverage WCDs.

In some aspects, the relay WCD may advertise U2U relaying support independent of a Uu link quality or RRC states (for example, between the relay WCD and the network node). The source WCD may perform relay WCD selection based at least in part on remote relay WCD link quality criteria or other higher layer criteria. In some aspects, the relay WCD may support Model A discovery by periodically announcing itself to support remote WCDs (for example, WCDs out of coverage of the network node) with relay WCD selection.

In fifth operation 725, the source WCD, the relay WCD and the destination WCD may perform route discovery. Route discovery may include one or more operations through which the source WCD discovers a route (for example, via the relay WCD) that supports reaching the destination WCD (for example, a destination WCD known or unknown to the source WCD) that supports either a ProSe service (for example, a ProSe service that matches a ProSe service of the source WCD), that is a member of a group (for example, a same group as the source WCD), or corresponds to application user info (for example, that matches applications user information associated with the source WCD).

Route discovery may use a Model A approach (for example, a proactive approach) where WCDs announce availability. For example, the destination WCD may announce availability to the relay WCD, and the relay WCD may store an identifier of the destination WCD (for example, in a routing table). Additionally or alternatively, the routing WCD may announce availability to the source WCD or the destination WCD, and the source WCD or the destination WCD may store an identifier of the destination WCD (for example, in a routing table).

Route discovery may use a Model B approach (for example, on-demand approach) where WCDs query for accessible (for example, reachable) WCDs. A receiving WCD that receives the query may respond with an indication that the receiving WCD is accessible or that one or more additional WCDs are accessible via the receiving WCD (for example, where the receiving WCD is a relay WCD).

In some aspects, the source WCD or the destination WCD may select a best route among one or more discovered routes before relay connection setup. In some aspects, route selection may be based at least in part on satisfying one or more configured criteria. For example, the one or more configured criteria may include a radio link quality criteria (for example, SDiscovery-RSRP or sidelink-RSRP thresholds for the relay WCD), an upper layer criteria (for example, an end-to-end discovery message (e.g., ProSe service matching) contents). The source WCD or the destination WCD may be configured with route selection link quality thresholds via a SIB when in-coverage of the network node or via a pre-configuration when out-of-coverage.

In a sixth operation 730, the source WCD, the relay WCD and the destination WCD may perform relay connection setup. For example, the source WCD, the relay WCD and the destination WCD may perform a unicast link setup, establish communication security, or manage a QoS for communications used a route from the source WCD through the relay WCD and to the destination WCD.

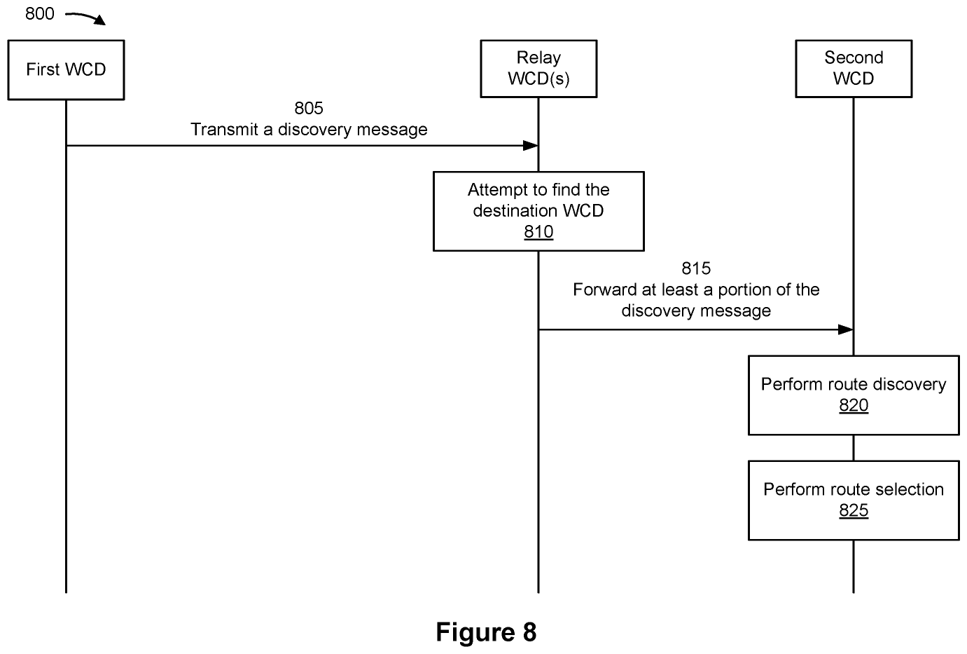

FIG. 8 is a diagram illustrating an example 800 of U2U relay operations, such as relay discovery or route discovery, in accordance with the present disclosure. Example 800 illustrates a discovery procedure (for example, relay discovery described in connection with operation 720 or route discovery described in connection with operation 725, described in connection with FIG. 7). As shown in FIG. 8, first WCD (for example, a source WCD or a destination WCD) may attempt to communicate with a second WCD (for example, a source WCD or a destination WCD) via a relay WCD (for example, a relay UE) of one or more relay WCDs. Before the operations of example 800, the first WCD may be unaware of the presence of the one or more relay WCDs or a route to the second WCD via the relay WCD. In some networks, multiple relay WCDs of the one or more relay WCDs may provide different routes to the second WCD.

In a first operation 805, the first WCD transmits a discovery message to the relay WCD. The discovery message (for example, a Discoveryrelaying message) may include announcer user information (for example, user information associated with the first WCD), an RSC, or relaying information, among other examples. The relaying information may indicate second WCD user information that indicates the second WCD to the relay WCD. The relaying information may include end-to-end WCD discovery information (for example, E2EUEdisc_info). The end-to-end WCD discovery information may include, or may be included in, a container to be forwarded to by the relay WCD. The container (for example, the E2EUEdisc_info container) may include a complete Model A (announcement) or Model B (Solicitation and Response) message. In some aspects, the container may be transparent or non-transparent to the relay WCD based at least in part on a security design (for example, as indicated in configuration information).

In some aspects, the discovery message may be a PC5-S discovery message used to request the relay WCD to relay a discovery message. For example, the first WCD or the second WCD may use the PC5-S discovery message to relay discovery messages when the first WCD or the second WCD are out-of-coverage WCDs (for example, remote WCDs).

In a second operation 810, the one or more relay WCDs may attempt to find the second WCD. In some aspects, the one or more relay WCDs may check a list of accessible (for example, reachable) WCDs based at least in part on one or more discovery messages (for example, previously received discovery messages). For example, the one or more relay WCDs may use the second WCD information to check a remote WCD reachability table or other data store that is based at least in part on previously received discovery messages (for example, announcements or solicitation and response messages).

In a third operation 815, the one or more relay WCDs may forward (for example, transmit), and the second WCD may receive, at least a portion of the discovery message. For example, the one or more WCDs may transmit a new message that includes relay WCD user information, the RSC, a relay WCD indication, announcer user information, or the end-to-end WCD discovery information.

In some aspects, the one or more relay WCDs may forward at least a portion of the discovery message to the second WCD using the second WCD user information. For example, the one or more relay WCDs may transmit the portion of the discovery message to an address associated with the second WCD based at least in part on finding the second WCD in a data store indicating accessibility of the second WCD to the one or more relay WCDs. However, based at least in part on the one or more relay WCDs, or a subset of the one or more relay WCDs, not finding the second WCD, the one or more relay WCDs or the subset may transmit the portion of the discovery message to a configured destination layer-2 identification. The configured destination layer-2 identification may be based at least in part on the ProSe policy for relaying the discovery announcement.

In a fourth operation 820, the second WCD may perform route discovery. For example, the second WCD may perform one or more operations described in connection with operation 725 of FIG. 7.

In a fifth operation 825, the second WCD may perform route selection. For example, the second WCD may perform one or more operations described in connection with operation 725 of FIG. 7. In some aspects, route selection may be based at least in part on a radio link quality criteria, with the radio link criteria be based at least in part on a radio link between the first WCD and the relay WCD, a radio link between the relay WCD and the second WCD, or an end-to-end radio link between the first WCD and the second WCD, among other examples. The radio link quality criteria may be associated with a signal strength metrics, such as RSRP or signal-to-interference-plus-noise ratio (SINR). In some aspects, the second WCD may select the route including a particular relay WCD based at least in part on a radio link quality metrics satisfying a threshold. Additionally or alternatively, the second WCD may select the route including a particular relay WCD based at least in part on an upper layer criteria, such as end-to-end discovery message contents (for example, ProSe service matching).

FIG. 9 is a diagram illustrating an example 900 of U2U relay operations, such as relay discovery or route discovery, in accordance with the present disclosure. Example 900 illustrates a discovery procedure (for example, relay discovery described in connection with operation 720 or route discovery described in connection with operation 725, described in connection with FIG. 7). As shown in FIG. 9, first WCD (for example, a source WCD or a destination WCD) may attempt to communicate with a second WCD (for example, a source WCD or a destination WCD) via a relay WCD (for example, a relay UE) of one or more relay WCDs. Before the operations of example 900, the first WCD may be unaware of the presence of the one or more relay WCDs or a route to the second WCD via the relay WCD. In some networks, multiple relay WCDs of the one or more relay WCDs may provide different routes to the second WCD.

In a first operation 905, the first WCD transmits a discovery announcement to the relay WCD. The discovery announcement may include announcer user information (for example, user information associated with the first WCD), an RSC, or end-to-end WCD discovery information (for example, E2EUEdisc_info). The end-to-end WCD discovery information may include, or may be included in, a container to be forwarded to by the relay WCD. The container (for example, the E2EUEdisc_info container) may include a complete Model A (announcement) message. In some aspects, the container may be transparent or non-transparent to the relay WCD based at least in part on a security design (for example, as indicated in configuration information).

In some aspects, the discovery message may be a PC5-S discovery message used to request the relay WCD to relay a discovery message. For example, the first WCD or the second WCD may use the PC5-S discovery message to relay discovery messages when the first WCD or the second WCD are out-of-coverage WCDs (for example, remote WCDs).

In a second operation 910, the one or more relay WCDs may identify accessible WCDs. In some aspects, the one or more relay WCDs may check a list of accessible (for example, reachable) WCDs based at least in part on one or more discovery messages (for example, previously received discovery messages). The one or more relay WCDs may identified based at least in part on associated with an RSC or other information included in the discovery announcement.

In a third operation 915, the one or more relay WCDs may transmit, and the second WCD may receive, a relay discovery message. The relay discovery message may include at least a portion of the discovery message. For example, the one or more WCDs may transmit the relay discovery message that includes relay WCD user information, the RSC, a relay WCD indication, announcer (for example, first WCD) user information, or the end-to-end WCD discovery information. In some aspects, the one or more relay WCDs may further indicate support for layer-2 or layer-3 relay operation support. In some aspects, the relay discovery message may include security protection using security material corresponding to the RSC.

In some aspects, the one or more relay WCDs may transmit the portion of the discovery message to a configured destination layer-2 identification. The configured destination layer-2 identification may be based at least in part on the ProSe policy for relaying the discovery message.

In some aspects, the one or more relay WCDs may announce accessible UEs along with, as part of, or in addition to the portion of the discovery announcement. For example the one or more relay WCDs may identification all accessible WCDs to the second WCD (for example, via a direct communication or via an announcement transmitted to the configured destination layer-2 identification, among other examples).

In a fourth operation 920, the second WCD may perform route discovery. For example, the second WCD may perform one or more operations described in connection with operation 725 of FIG. 7.

In a fifth operation 925, the second WCD may perform route selection. For example, the second WCD may perform one or more operations described in connection with operation 730 of FIG. 7.

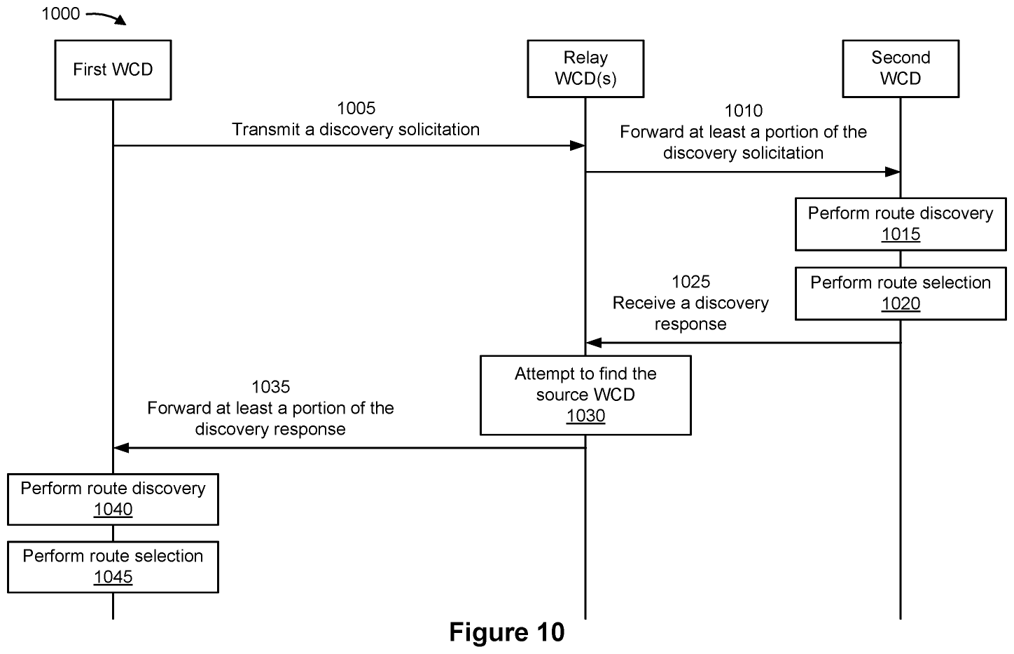

FIG. 10 is a diagram illustrating an example 1000 of U2U relay operations, such as relay discovery or route discovery, in accordance with the present disclosure. Example 1000 illustrates a discovery procedure (for example, relay discovery described in connection with operation 720 or route discovery described in connection with operation 725, described in connection with FIG. 7). As shown in FIG. 10, first WCD (for example, a source WCD, a destination WCD, or a discoverer WCD) may attempt to communicate with a second WCD (for example, a source WCD, a destination WCD, or a discoveree WCD) via a relay WCD (for example, a relay UE) of one or more relay WCDs. Before the operations of example 1000, the first WCD may be unaware of the presence of the one or more relay WCDs or a route to the second WCD via the relay WCD. In some networks, multiple relay WCDs of the one or more relay WCDs may provide different routes to the second WCD.

In a first operation 1005, the first WCD transmits a discovery solicitation to the relay WCD. The discovery announcement may include discoverer user information (for example, user information associated with the first WCD), an RSC, or end-to-end WCD discovery information (for example, E2EUEdisc_info). The end-to-end WCD discovery information may include, or may be included in, a container to be forwarded to by the relay WCD. The container (for example, the E2EUEdisc_info container) may include a complete Model B (solicitation) message. In some aspects, the container may be transparent or non-transparent to the relay WCD based at least in part on a security design (for example, as indicated in configuration information).

In some aspects, the discovery message may be a PC5-S discovery message used to request the relay WCD to relay a discovery message. For example, the first WCD or the second WCD may use the PC5-S discovery message to relay discovery messages when the first WCD or the second WCD are out-of-coverage WCDs (for example, remote WCDs).

In a second operation 1010, the one or more relay WCDs may forward (for example, transmit), and the second WCD may receive, at least a portion of the discovery solicitation. For example, the one or more WCDs may transmit a message that includes relay WCD user information, the RSC, a relay WCD indication, discoverer user information, or the end-to-end WCD discovery information, among other examples.

In some aspects, the one or more relay WCDs may forward at least a portion of the discovery message to the second WCD using the second WCD user information. For example, the one or more relay WCDs may transmit the portion of the discovery message to an address associated with the second WCD based at least in part on finding the second WCD in a data store indicating accessibility of the second WCD to the one or more relay WCDs. However, based at least in part on the one or more relay WCDs, or a subset of the one or more relay WCDs, not finding the second WCD, the one or more relay WCDs or the subset may transmit the portion of the discovery message to a configured destination layer-2 identification. The configured destination layer-2 identification may be based at least in part on the ProSe policy for relaying the discovery solicitation.

In a third operation 1015, the second WCD may perform route discovery. For example, the second WCD may perform one or more operations described in connection with operation 725 of FIG. 7.

In a fourth operation 1020, the second WCD may perform route selection. For example, the second WCD may perform one or more operations described in connection with operation 730 of FIG. 7.

In a fifth operation 1025, second WCD may transmit a solicitation response. The solicitation response may include discoveree user information (for example, user information associated with the second WCD), the RSC, discoverer user information (for example, user information associated with the first WCD), or end-to-end WCD discovery information (for example, E2EUEdisc_info). The end-to-end WCD discovery information may include, or may be included in, a container to be forwarded to by the relay WCD. The container (for example, the E2EUEdisc_info container) may include a complete Model B (solicitation response) message. In some aspects, the container may be transparent or non-transparent to the relay WCD based at least in part on a security design (for example, as indicated in configuration information).

In a sixth operation 1030, the one or more relay WCDs may attempt to find the source WCD associated with the discovery response. In some aspects, the one or more relay WCDs may check a list of accessible (for example, reachable) WCDs based at least in part on one or more discovery messages (for example, previously received discovery messages). For example, the one or more relay WCDs may use discoverer WCD information to check a remote WCD reachability table or other data store that is based at least in part on previously received discovery messages (for example, announcements or solicitation and response messages).

In a seventh operation 1035, the one or more relay WCDs may forward (for example, transmit), and the first WCD may receive, at least a portion of the discovery response. For example, the one or more WCDs may transmit a message that includes relay WCD user information, the RSC, a relay WCD indication, discoveree user information, or the end-to-end WCD discovery information, among other examples.

In an eighth operation 1040, the first WCD may perform route discovery. For example, the first WCD may perform one or more operations described in connection with operation 725 of FIG. 7.

In a ninth operation 1045, the first WCD may perform route selection. For example, the first WCD may perform one or more operations described in connection with operation 725 of FIG. 7. In some aspects, route selection may be based at least in part on a radio link quality criteria, with the radio link criteria be based at least in part on a radio link between the first WCD and the relay WCD, a radio link between the relay WCD and the second WCD, or an end-to-end radio link between the first WCD and the second WCD, among other examples. The radio link quality criteria may be associated with a signal strength metrics, such as RSRP or SINR. In some aspects, the first WCD may select the route including a particular relay WCD based at least in part on a radio link quality metrics satisfying a threshold. Additionally or alternatively, the first WCD may select the route including a particular relay WCD based at least in part on an upper layer criteria, such as end-to-end discovery message contents (for example, ProSe service matching).

FIG. 11 is a flowchart illustrating an example process 1100 performed, for example, by a first WCD in accordance with the present disclosure. Example process 1100 is an example where the WCD (for example, a source WCD, a first WCD, or UE 120) performs operations associated with U2U relay operations.

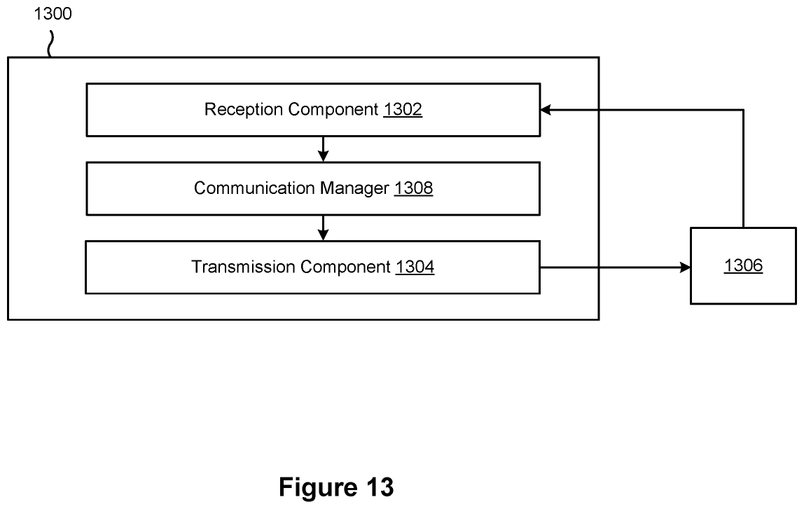

As shown in FIG. 11, in some aspects, process 1100 may include initiating, based at least in part on a determination to participate in U2U relay communication, a discovery procedure to discover one or more of access to a second WCD or services provided by the second WCD, the second WCD being accessible via a third WCD (block 1110). For example, the WCD (such as by using communication manager 140 or communication manager 1308, depicted in FIG. 13) may initiate, based at least in part on a determination to participate in U2U relay communication, a discovery procedure to discover one or more of access to a second WCD or services provided by the second WCD, the second WCD being accessible via a third WCD, as described above.

As further shown in FIG. 11, in some aspects, process 1100 may include communicating (e.g., U2U communications) with the second WCD via the third WCD based at least in part on the discovery procedure (block 1120). For example, the WCD (such as by using communication manager 140 or communication manager 1308, depicted in FIG. 13) may communicate (e.g., U2U communications) with the second WCD via the third WCD based at least in part on the discovery procedure, as described above.

Process 1100 may include additional aspects, such as any single aspect or any combination of aspects described below or in connection with one or more other processes described elsewhere herein.

In a first additional aspect, the determination to participate in U2U relay communication is based at least in part on a proximity services policy provisioned to the WCD, the proximity service policy indicating an authorization policy and parameters for U2U relay discovery and U2U relay communication.

In a second additional aspect, alone or in combination with the first aspect, the parameters comprise one or more of a mapping of an application identifier to one or more RSCs, or a mapping of an application service type to one or more RSCs.

In a third additional aspect, alone or in combination with one or more of the first and second aspects, each of the RSCs is associated with one or more of a user information identifier associated with the first WCD, a U2U relay layer indicator indicating whether relay type is layer-2 or layer-3 U2U relay, security parameters for discovery, defaulting destination layer-2 identifiers for transmitting or receiving different types of discovery messages, or ending-to-end quality of service parameters.

In a fourth additional aspect, alone or in combination with one or more of the first through third aspects, the discovery procedure discovers the third WCD, the third WCD supporting providing access to the second WCD associated with one or more of a proximity service, a group associated with the first WCD, or application user information associated with the proximity service.

In a fifth additional aspect, alone or in combination with one or more of the first through fourth aspects, process 1100 includes one or more of receiving, from the third WCD, a relay discovery announcement message indicating support or a lack of support for relaying communications between the first WCD and the second WCD, or transmitting a relay discovery message to the second WCD via the third WCD.

In a sixth additional aspect, alone or in combination with one or more of the first through fifth aspects, the relay discovery message comprises one or more of a discovery relaying message that indicates that associated end-to-end discovery messages are to be relayed by the third WCD to the second WCD, a discovery announcement message that indicates that the first WCD is accessible to the third WCD, or a discovery solicitation message for querying WCDs accessible via the third WCD.

In a seventh additional aspect, alone or in combination with one or more of the first through sixth aspects, the relay discovery message comprises one or more of a RSC, user information associated with the first WCD corresponding to an RSC, user information associated with the second WCD, or ending-to-end proximity services direct discovery information, indicating proximity services supported by the first WCD or the second WCD, in a container that is to be forwarded to accessible WCDs by the third WCD.

In an eighth additional aspect, alone or in combination with one or more of the first through seventh aspects, the container comprises a direct discovery announcement message, a direct discovery solicitation for a response, or one or more information elements of the direct discovery announcement message or the direct discovery solicitation.

In a ninth additional aspect, alone or in combination with one or more of the first through eighth aspects, the end-to-end proximity services direct discovery information is transparent or non-transparent to the third WCD based at least in part on a security configuration.

In a tenth additional aspect, alone or in combination with one or more of the first through ninth aspects, process 1100 includes receiving a response to the discovery solicitation message, wherein the response to the discovery solicitation message indicates one or more of user information associated with the second WCD, user information associated with the third WCD, a relay service code, a relaying indication, or contents of an end-to-end discovery message included in the discovery solicitation message.

In an eleventh additional aspect, alone or in combination with one or more of the first through tenth aspects, process 1100 includes selecting the third WCD based at least in part on one or more of relaying discovery selection criteria, ending-to-end direct discovery selection criteria, radio link quality between the first WCD and the third WCD, or an end-to-end radio link quality between the first WCD and the second WCD via the third WCD.

In a twelfth additional aspect, alone or in combination with one or more of the first through eleventh aspects, the relay discovery selection criteria are based at least in part on the third WCD supporting one or more relay discovery parameters comprising one or more of user information associated with the third WCD, or a relay service code.

Although FIG. 11 shows example blocks of process 1100, in some aspects, process 1100 may include additional blocks, fewer blocks, different blocks, or differently arranged blocks than those depicted in FIG. 11. Additionally or alternatively, two or more of the blocks of process 1100 may be performed in parallel.

FIG. 12 is a flowchart illustrating an example process 1200 performed, for example, by a relay WCD in accordance with the present disclosure. Example process 1200 is an example where the WCD (for example, a source WCD, a relay WCD, or UE 120) performs operations associated with U2U relay operations.

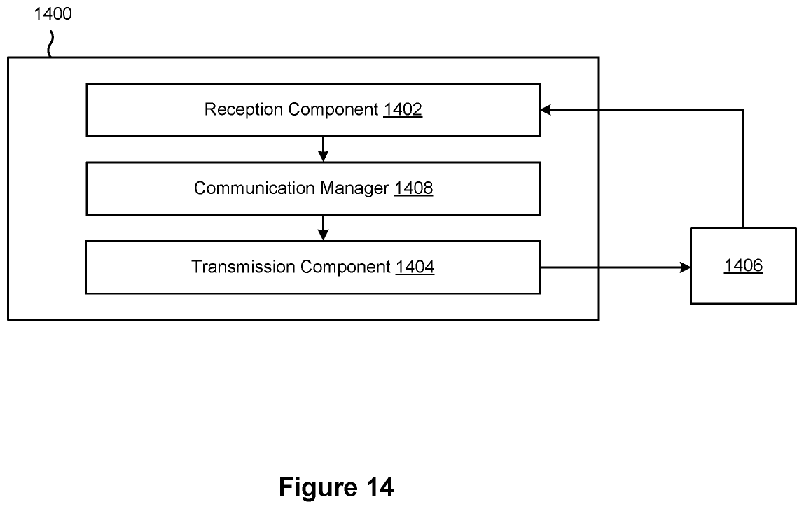

As shown in FIG. 12, in some aspects, process 1200 may include performing a discovery procedure for U2U relay communication, the discovery procedure comprising one or more of: advertising to a first WCD or a second WCD to indicate support for U2U relay services, transmitting a response to a solicitation from the first WCD or the second WCD, the response indicating support for U2U relay services, discovering the first WCD or the second WCD as accessible via the relay WCD, or advertising the first WCD or the second WCD as accessible via the relay WCD (block 1210). For example, the WCD (such as by using communication manager 150 or communication manager 1408, depicted in FIG. 14) may perform a discovery procedure for U2U relay communication, the discovery procedure comprising one or more of: advertising to a first WCD or a second WCD to indicate support for U2U relay services, transmitting a response to a solicitation from the first WCD or the second WCD, the response indicating support for U2U relay services, discovering the first WCD or the second WCD as accessible via the relay WCD, or advertising the first WCD or the second WCD as accessible via the relay WCD, as described above.

As further shown in FIG. 12, in some aspects, process 1200 may include relaying communications between the first WCD and the second WCD based at least in part on performing the discovery procedure (block 1220). For example, the WCD (such as by using communication manager 150 or communication manager 1408, depicted in FIG. 14) may relay communications between the first WCD and the second WCD based at least in part on performing the discovery procedure, as described above.

Process 1200 may include additional aspects, such as any single aspect or any combination of aspects described below or in connection with one or more other processes described elsewhere herein.

In a first additional aspect, the one or more of discovering or advertising comprises one or more of discovering or advertising when connected to a radio access network, or discovering or advertising when disconnected to the radio access network.

In a second additional aspect, alone or in combination with the first aspect, the discovery procedure discovers that the relay WCD supports providing access to the second WCD associated with one or more of a proximity service, a group associated with the first WCD, or application user information associated with the proximity service.

In a third additional aspect, alone or in combination with one or more of the first and second aspects, advertising support for U2U relay services comprises one or more of: transmitting, to the first WCD, a relay discovery announcement message indicating support or a lack of support for relaying communications between the first WCD and the second WCD, or forwarding a relay discovery message from the first WCD to the second WCD.

In a fourth additional aspect, alone or in combination with one or more of the first through third aspects, the relay discovery message comprises one or more of a discovery relaying message that indicates that associated end-to-end discovery messages are to be relayed by the relay WCD to the second WCD, a discovery announcement message that indicates that the first WCD is accessible to the relay WCD, or a discovery solicitation message for querying WCDs accessible via the relay WCD.

In a fifth additional aspect, alone or in combination with one or more of the first through fourth aspects, the relay discovery message comprises one or more of a RSC, user information associated with the first WCD corresponding to an RSC, user information associated with the second WCD, or ending-to-end proximity services direct discovery information, indicating proximity services supported by the first WCD or the second WCD, in a container that is to be forwarded to accessible WCDs by the relay WCD.

In a sixth additional aspect, alone or in combination with one or more of the first through fifth aspects, the container comprises a direct discovery announcement message, a direct discovery solicitation for a response, or one or more information elements of the direct discovery announcement message or the direct discovery solicitation.

In a seventh additional aspect, alone or in combination with one or more of the first through sixth aspects, the end-to-end proximity services direct discovery information is transparent or non-transparent to the relay WCD based at least in part on a security configuration.

In an eighth additional aspect, alone or in combination with one or more of the first through seventh aspects, process 1200 includes transmitting a response to the discovery solicitation message, wherein the response to the discovery solicitation message indicates one or more of user information associated with the second WCD, user information associated with the relay WCD, a relay service code, a relaying indication, or contents of an end-to-end discovery message included in the discovery solicitation message.

Although FIG. 12 shows example blocks of process 1200, in some aspects, process 1200 may include additional blocks, fewer blocks, different blocks, or differently arranged blocks than those depicted in FIG. 12. Additionally or alternatively, two or more of the blocks of process 1200 may be performed in parallel.

FIG. 13 is a diagram of an example apparatus 1300 for wireless communication. The apparatus 1300 may be a WCD, or a WCD may include the apparatus 1300. In some aspects, the apparatus 1300 includes a reception component 1302 and a transmission component 1304, which may be in communication with one another (for example, via one or more buses or one or more other components). As shown, the apparatus 1300 may communicate with another apparatus 1306 (such as a UE, a base station, or another wireless communication device) using the reception component 1302 and the transmission component 1304. As further shown, the apparatus 1300 may include a communication manager 1308 (for example, the communication manager 140).

In some aspects, the apparatus 1300 may be configured to perform one or more operations described herein in connection with FIGS. 7-10. Additionally or alternatively, the apparatus 1300 may be configured to perform one or more processes described herein, such as process 1100 of FIG. 11. In some aspects, the apparatus 1300 or one or more components shown in FIG. 13 may include one or more components of the WCD described in connection with FIG. 2. Additionally or alternatively, one or more components shown in FIG. 13 may be implemented within one or more components described in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the WCD described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the WCD described in connection with FIG. 2. In some aspects, the transmission component 1304 may be co-located with the reception component 1302 in a transceiver.

The communication manager 1308 may initiate, based at least in part on a determination to participate in U2U relay communication, a discovery procedure to discover one or more of access to a second WCD or services provided by the second WCD, the second WCD being accessible via a third WCD. The communication manager 1308 or the transmission component 1304 may communicate (e.g., U2U communications) with the second WCD via the third WCD based at least in part on the discovery procedure.

The reception component 1302 may receive a response to the discovery solicitation message wherein the response to the discovery solicitation message indicates one or more of: user information associated with the second WCD, user information associated with the third WCD, a relay service code, a relaying indication, or contents of an end-to-end discovery message included in the discovery solicitation message.

The communication manager 1308 may select the third WCD based at least in part on one or more of relay discovery selection criteria, end-to-end direct discovery selection criteria, radio link quality between the first WCD and the third WCD, or an end-to-end radio link quality between the first WCD and the second WCD via the third WCD.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally or alternatively, a set of (one or more) components shown in FIG. 13 may perform one or more functions described as being performed by another set of components shown in FIG. 13.

FIG. 14 is a diagram of an example apparatus 1400 for wireless communication. The apparatus 1400 may be a WCD, or a WCD may include the apparatus 1400. In some aspects, the apparatus 1400 includes a reception component 1402 and a transmission component 1404, which may be in communication with one another (for example, via one or more buses or one or more other components). As shown, the apparatus 1400 may communicate with another apparatus 1406 (such as a UE, a base station, or another wireless communication device) using the reception component 1402 and the transmission component 1404. As further shown, the apparatus 1400 may include a communication manager 1408 (for example, the communication manager 150).

In some aspects, the apparatus 1400 may be configured to perform one or more operations described herein in connection with FIGS. 7-10. Additionally or alternatively, the apparatus 1400 may be configured to perform one or more processes described herein, such as process 1200 of FIG. 12. In some aspects, the apparatus 1400 or one or more components shown in FIG. 14 may include one or more components of the WCD described in connection with FIG. 2. Additionally or alternatively, one or more components shown in FIG. 14 may be implemented within one or more components described in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the WCD described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the WCD described in connection with FIG. 2. In some aspects, the transmission component 1404 may be co-located with the reception component 1402 in a transceiver.

The communication manager 1408 may perform a discovery procedure for U2U relay communication, the discovery procedure comprising one or more of advertising to a first WCD or a second WCD to indicate support for U2U relay services, transmitting a response to a solicitation from the first WCD or the second WCD, the response indicating support for U2U relay services, discovering the first WCD or the second WCD as accessible via the relay WCD, or advertising the first WCD or the second WCD as accessible via the relay WCD. The communication manager 1308 or the transmission component 1404 may relay communications between the first WCD and the second WCD based at least in part on performing the discovery procedure.

The transmission component 1404 may transmit a response to the discovery solicitation message wherein the response to the discovery solicitation message indicates one or more of: user information associated with the second WCD, user information associated with the relay WCD, a relay service code, a relaying indication, or contents of an end-to-end discovery message included in the discovery solicitation message.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a first wireless communication device (WCD), comprising: initiating, based at least in part on a determination to participate in user-equipment-to-user-equipment (U2U) relay communication, a discovery procedure to discover one or more of access to a second WCD or services provided by the second WCD, the second WCD being accessible via a third WCD; and communicating (e.g., U2U communications) with the second WCD via the third WCD based at least in part on the discovery procedure.

Aspect 2: The method of Aspect 1, wherein the determination to participate in U2U relay communication is based at least in part on a proximity services policy provisioned to the WCD, the proximity service policy indicating an authorization policy and parameters for U2U relay discovery and U2U relay communication.

Aspect 3: The method of Aspect 2, wherein the parameters comprise one or more of: a mapping of an application identifier to one or more relay service codes (RSC), or a mapping of an application service type to one or more RSCs.

Aspect 4: The method of Aspect 3, wherein each of the RSCs is associated with one or more of: a user information identifier associated with the first WCD, a U2U relay layer indicator indicating whether relay type is layer-2 or layer-3 U2U relay, security parameters for discovery, default destination layer-2 identifiers for transmitting or receiving different types of discovery messages, or end-to-end quality of service parameters.

Aspect 5: The method of any of Aspects 1-4, wherein the discovery procedure discovers the third WCD, the third WCD supporting providing access to the second WCD associated with one or more of: a proximity service, a group associated with the first WCD, or application user information associated with the proximity service.

Aspect 6: The method of any of Aspects 1-4, further comprising one or more of: receiving, from the third WCD, a relay discovery announcement message indicating support or a lack of support for relaying communications between the first WCD and the second WCD, or transmitting a relay discovery message to the second WCD via the third WCD.

Aspect 7: The method of Aspect 6, wherein the relay discovery message comprises one or more of: a discovery relaying message that indicates that associated end-to-end discovery messages are to be relayed by the third WCD to the second WCD, a discovery announcement message that indicates that the first WCD is accessible to the third WCD, or a discovery solicitation message for querying WCDs accessible via the third WCD.

Aspect 8: The method of Aspect 7, wherein the relay discovery message comprises one or more of: a relay service code (RSC), user information associated with the first WCD corresponding to an RSC, user information associated with the second WCD, or end-to-end proximity services direct discovery information, indicating proximity services supported by the first WCD or the second WCD, in a container that is to be forwarded to accessible WCDs by the third WCD.

Aspect 9: The method of Aspect 8, wherein the container comprises: a direct discovery announcement message, a direct discovery solicitation for a response, or one or more information elements of the direct discovery announcement message or the direct discovery solicitation.

Aspect 10: The method of any of Aspects 8 or 9, wherein the end-to-end proximity services direct discovery information is transparent or non-transparent to the third WCD based at least in part on a security configuration.

Aspect 11: The method of any of Aspects 7-10, further comprising receiving a response to the discovery solicitation message, wherein the response to the discovery solicitation message indicates one or more of: user information associated with the second WCD, user information associated with the third WCD, a relay service code, a relaying indication, or contents of an end-to-end discovery message included in the discovery solicitation message.

Aspect 12: The method of any of Aspects 1-11, further comprising selecting the third WCD based at least in part on one or more of: relay discovery selection criteria, end-to-end direct discovery selection criteria, radio link quality between the first WCD and the third WCD, or an end-to-end radio link quality between the first WCD and the second WCD via the third WCD.

Aspect 13: The method of Aspect 12, wherein the relay discovery selection criteria are based at least in part on the third WCD supporting one or more relay discovery parameters comprising one or more of: user information associated with the third WCD, or a relay service code.

Aspect 14: A method of wireless communication performed by a relay wireless communication device (WCD), comprising: performing a discovery procedure for user-equipment-to-user-equipment (U2U) relay communication, the discovery procedure comprising one or more of: advertising to a first WCD or a second WCD to indicate support for U2U relay services, transmitting a response to a solicitation from the first WCD or the second WCD, the response indicating support for U2U relay services, discovering the first WCD or the second WCD as accessible via the relay WCD, or advertising the first WCD or the second WCD as accessible via the relay WCD; and relaying communications between the first WCD and the second WCD based at least in part on performing the discovery procedure.

Aspect 15: The method of Aspect 14, wherein the one or more of discovering or advertising comprises one or more of: discovering or advertising when connected to a radio access network, or discovering or advertising when disconnected to the radio access network.

Aspect 16: The method of any of Aspects 14 or 15, wherein the discovery procedure discovers that the relay WCD supports providing access to the second WCD associated with one or more of: a proximity service, a group associated with the first WCD, or application user information associated with the proximity service.

Aspect 17: The method of any of Aspects 14-16, wherein advertising support for U2U relay services comprises one or more of: transmitting, to the first WCD, a relay discovery announcement message indicating support or a lack of support for relaying communications between the first WCD and the second WCD, or forwarding a relay discovery message from the first WCD to the second WCD.

Aspect 18: The method of Aspect 17, wherein the relay discovery message comprises one or more of: a discovery relaying message that indicates that associated end-to-end discovery messages are to be relayed by the relay WCD to the second WCD, a discovery announcement message that indicates that the first WCD is accessible to the relay WCD, or a discovery solicitation message for querying WCDs accessible via the relay WCD.

Aspect 19: The method of Aspect 18, wherein the relay discovery message comprises one or more of: a relay service code (RSC), user information associated with the first WCD corresponding to an RSC, user information associated with the second WCD, or end-to-end proximity services direct discovery information, indicating proximity services supported by the first WCD or the second WCD, in a container that is to be forwarded to accessible WCDs by the relay WCD.

Aspect 20: The method of Aspect 19, wherein the container comprises: a direct discovery announcement message, a direct discovery solicitation for a response, or one or more information elements of the direct discovery announcement message or the direct discovery solicitation.

Aspect 21: The method of any of Aspects 19 or 20, wherein the end-to-end proximity services direct discovery information is transparent or non-transparent to the relay WCD based at least in part on a security configuration.

Aspect 22: The method of Aspect 21, further comprising transmitting a response to the discovery solicitation message, wherein the response to the discovery solicitation message indicates one or more of: user information associated with the second WCD, user information associated with the relay WCD, a relay service code, a relaying indication, or contents of an end-to-end discovery message included in the discovery solicitation message.

Aspect 23: An apparatus for wireless communication at a device, comprising a processor; memory coupled with the processor; and instructions stored in the memory and executable by the processor to cause the apparatus to perform the method of one or more of Aspects 1-22.

Aspect 24: A device for wireless communication, comprising a memory and one or more processors coupled to the memory, the one or more processors configured to perform the method of one or more of Aspects 1-22.

Aspect 25: An apparatus for wireless communication, comprising at least one means for performing the method of one or more of Aspects 1-22.

Aspect 26: A non-transitory computer-readable medium storing code for wireless communication, the code comprising instructions executable by a processor to perform the method of one or more of Aspects 1-22.

Aspect 27: A non-transitory computer-readable medium storing a set of instructions for wireless communication, the set of instructions comprising one or more instructions that, when executed by one or more processors of a device, cause the device to perform the method of one or more of Aspects 1-22.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, since those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “or,” unless explicitly stated otherwise (for example, if used in combination with “either” or “only one of”).

What is claimed is:

1. A first wireless communication device (WCD) for wireless communication, comprising:
a memory; and
one or more processors, coupled to the memory, configured to:
initiate, based at least in part on a determination to participate in user-equipment-to-user-equipment (U2U) relay communication, a discovery procedure to discover one or more of access to a second WCD or services provided by the second WCD, the second WCD being accessible via a third WCD; and
communicate one or more U2U communications with the second WCD via the third WCD based at least in part on the discovery procedure.

2. The first WCD of claim Error! Reference source not found., wherein the determination to participate in U2U relay communication is based at least in part on a proximity services policy provisioned to the WCD, the proximity service policy indicating an authorization policy and parameters for U2U relay discovery and U2U relay communication.

3. The first WCD of claim Error! Reference source not found., wherein the parameters comprise one or more of:
a mapping of an application identifier to one or more relay service codes (RSCs), or
a mapping of an application service type to one or more RSCs.

4. The first WCD of claim Error! Reference source not found., wherein each of the RSCs is associated with one or more of:
a user information identifier associated with the first WCD,
a U2U relay layer indicator indicating whether relay type is layer-2 or layer-3 U2U relay,
security parameters for discovery,
default destination layer-2 identifiers for transmitting or receiving different types of discovery messages, or
end-to-end quality of service parameters.

5. The first WCD of claim Error! Reference source not found., wherein the discovery procedure discovers the third WCD, the third WCD supporting providing access to the second WCD associated with one or more of:
a proximity service,
a group associated with the first WCD, or
application user information associated with the proximity service.

6. The first WCD of claim Error! Reference source not found., wherein the one or more processors are further configured to one or more of:
receive, from the third WCD, a relay discovery announcement message indicating support or a lack of support for relaying communications between the first WCD and the second WCD, or
transmit a relay discovery message to the second WCD via the third WCD.

7. The first WCD of claim Error! Reference source not found., wherein the relay discovery message comprises one or more of:
a discovery relaying message that indicates that associated end-to-end discovery messages are to be relayed by the third WCD to the second WCD,
a discovery announcement message that indicates that the first WCD is accessible to the third WCD, or
a discovery solicitation message for querying WCDs accessible via the third WCD.

8. The first WCD of claim Error! Reference source not found., wherein the relay discovery message comprises one or more of:
a relay service code (RSC),
user information associated with the first WCD corresponding to an RSC,
user information associated with the second WCD, or
end-to-end proximity services direct discovery information, indicating proximity services supported by the first WCD or the second WCD, in a container that is to be forwarded to accessible WCDs by the third WCD.

9. The first WCD of claim Error! Reference source not found., wherein the container comprises:
a direct discovery announcement message,
a direct discovery solicitation for a response, or
one or more information elements of the direct discovery announcement message or the direct discovery solicitation.

10. The first WCD of claim Error! Reference source not found., wherein the end-to-end proximity services direct discovery information is transparent or non-transparent to the third WCD based at least in part on a security configuration.

11. The first WCD of claim Error! Reference source not found., wherein the one or more processors are further configured to receive a response to the discovery solicitation message, wherein the response to the discovery solicitation message indicates one or more of:
user information associated with the second WCD,
user information associated with the third WCD,
a relay service code,
a relaying indication, or
information elements of an end-to-end discovery message included in the discovery solicitation message.

12. The first WCD of claim Error! Reference source not found., wherein the one or more processors are further configured to select the third WCD based at least in part on one or more of:
relay discovery selection criteria,
end-to-end direct discovery selection criteria,
radio link quality between the first WCD and the third WCD, or
an end-to-end radio link quality between the first WCD and the second WCD via the third WCD.

13. The first WCD of claim Error! Reference source not found., wherein the relay discovery selection criteria are based at least in part on the third WCD supporting one or more relay discovery parameters comprising one or more of:
user information associated with the third WCD, or
a relay service code.

14. A relay wireless communication device (WCD) for wireless communication, comprising:
a memory; and
one or more processors, coupled to the memory, configured to:
perform a discovery procedure for user-equipment-to-user-equipment (U2U) relay communication, the discovery procedure comprising one or more of:
advertising, to a first WCD or a second WCD, support for U2U relay services,
transmit a response to a solicitation from the first WCD or the second WCD, the response indicating support for U2U relay services,
discover the first WCD or the second WCD as accessible via the relay WCD, or
advertise the first WCD or the second WCD as accessible via the relay WCD; and
relay U2U communications between the first WCD and the second WCD based at least in part on performing the discovery procedure.

15. The relay WCD of claim Error! Reference source not found., wherein the one or more of discovering or advertising comprises one or more of:
discover or advertising when connected to a radio access network, or
discover or advertising when disconnected to the radio access network.

16. The relay WCD of claim Error! Reference source not found., wherein the discovery procedure discovers that the relay WCD supports providing access to the second WCD associated with one or more of:
a proximity service,
a group associated with the first WCD, or
application user information associated with the proximity service.

17. The relay WCD of claim Error! Reference source not found., wherein advertising support for U2U relay services comprises one or more of:
transmit, to the first WCD, a relay discovery announcement message indicating support or a lack of support for relaying communications between the first WCD and the second WCD, or
forward a relay discovery message from the first WCD to the second WCD.

18. The relay WCD of claim Error! Reference source not found., wherein the relay discovery message comprises one or more of:
a discovery relaying message that indicates that associated end-to-end discovery messages are to be relayed by the relay WCD to the second WCD,
a discovery announcement message that indicates that the first WCD is accessible to the relay WCD, or
a discovery solicitation message for querying WCDs accessible via the relay WCD.

19. The relay WCD of claim Error! Reference source not found., wherein the relay discovery message comprises one or more of:
a relay service code (RSC),
user information associated with the first WCD corresponding to an RSC,
user information associated with the second WCD, or
end-to-end proximity services direct discovery information, indicating proximity services supported by the first WCD or the second WCD, in a container that is to be forwarded to accessible WCDs by the relay WCD.

20. The relay WCD of claim Error! Reference source not found., wherein the container comprises:
a direct discovery announcement message,
a direct discovery solicitation for a response, or
one or more information elements of the direct discovery announcement message or the direct discovery solicitation.

21. The relay WCD of claim Error! Reference source not found., wherein the end-to-end proximity services direct discovery information is transparent or non-transparent to the relay WCD based at least in part on a security configuration.

22. The relay WCD of claim Error! Reference source not found., wherein the one or more processors are further configured to transmit a response to the discovery solicitation message,
wherein the response to the discovery solicitation message indicates one or more of:
user information associated with the second WCD,
user information associated with the relay WCD,
a relay service code,
a relaying indication, or
contents of an end-to-end discovery message included in the discovery solicitation message.

23. A method of wireless communication performed by a first wireless communication device (WCD), comprising:
initiating, based at least in part on a determination to participate in user-equipment-to-user-equipment (U2U) relay communication, a discovery procedure to discover one or more of access to a second WCD or services provided by the second WCD, the second WCD being accessible via a third WCD; and
communicating one or more U2U communications with the second WCD via the third WCD based at least in part on the discovery procedure.

24. The method of claim 23, wherein the discovery procedure discovers the third WCD, the third WCD supporting providing access to the second WCD associated with one or more of:
a proximity service,
a group associated with the first WCD, or
application user information associated with the proximity service.

25. The method of claim 23, further comprising one or more of:
receiving, from the third WCD, a relay discovery announcement message indicating support or a lack of support for relaying communications between the first WCD and the second WCD, or
transmitting a relay discovery message to the second WCD via the third WCD.

26. The method of claim 25, wherein the relay discovery message comprises one or more of:
a discovery relaying message that indicates that associated end-to-end discovery messages are to be relayed by the third WCD to the second WCD,
a discovery announcement message that indicates that the first WCD is accessible to the third WCD, or
a discovery solicitation message for querying WCDs accessible via the third WCD.

27. A method of wireless communication performed by a relay wireless communication device (WCD), comprising:
performing a discovery procedure for user-equipment-to-user-equipment (U2U) relay communication, the discovery procedure comprising one or more of:
advertising, to a first WCD or a second WCD, support for U2U relay services,
transmitting a response to a solicitation from the first WCD or the second WCD, the response indicating support for U2U relay services,
discovering the first WCD or the second WCD as accessible via the relay WCD, or
advertising the first WCD or the second WCD as accessible via the relay WCD; and
relaying communications between the first WCD and the second WCD based at least in part on performing the discovery procedure.

28. The method of claim 27, wherein the discovery procedure discovers that the relay WCD supports providing access to the second WCD associated with one or more of:
a proximity service,
a group associated with the first WCD, or
application user information associated with the proximity service.

29. The method of claim 27, wherein advertising support for U2U relay services comprises one or more of:
transmitting, to the first WCD, a relay discovery announcement message indicating support or a lack of support for relaying communications between the first WCD and the second WCD, or
forwarding a relay discovery message from the first WCD to the second WCD.

30. The method of claim 29, wherein the relay discovery message comprises one or more of:
a discovery relaying message that indicates that associated end-to-end discovery messages are to be relayed by the relay WCD to the second WCD,
a discovery announcement message that indicates that the first WCD is accessible to the relay WCD, or
a discovery solicitation message for querying WCDs accessible via the relay WCD.
